(19) United States
(12) Patent Application Publication
(10) Pub. No.: US 2020/0110997 A1
(43) Pub. Date: Apr. 9, 2020

(54) ARTIFICIAL NEURAL NETWORK WITH CONTEXT PATHWAY

(71) Applicant: National Technology & Engineering Solutions of Sandia, LLC, Albuquerque, NM (US)

(72) Inventors: William Mark Severa, Albuquerque, NM (US); James Bradley Aimone, Albuquerque, NM (US)

(21) Appl. No.: 16/152,953

(22) Filed: Oct. 5, 2018

(51) Int. Cl. G06N 3/08; G06N 3/04

(52) U.S. Cl. CPC G06N 3/08; G06N 3/04

(57) ABSTRACT

An artificial neural network with a context pathway and a method of identifying a classification of information using an artificial neural network with a context pathway. An artificial neural network comprises up-stream layers and down-stream layers. An output of the up-stream layers is provided as input to the down-stream layers. A first input to the artificial neural network to the up-stream layers is configured to receive input data. A second input to the artificial neural network to the down-stream layers is configured to receive context data. The context data identifies a characteristic of information in the input data. The artificial neural network is configured to identify a classification of the information in the input data at an output of the down-stream layers using the context data.

### STATEMENT OF GOVERNMENT INTEREST

This invention was made with Government support under Contract No. DE-NA0003525 awarded by the United States Department of Energy/National Nuclear Security Administration. The United States Government has certain rights in this invention.

### BACKGROUND INFORMATION

### 1. Field

The present disclosure relates generally to artificial neural networks and more specifically to using context information for information processed by an artificial neural network to improve processing of the information by the artificial neural network.

### 2. Background

Artificial neural networks are computing systems inspired by the biological neural networks that constitute animal brains. Such systems learn to perform tasks by considering examples, generally without task-specific programming. An artificial neural network is based on a collection of connected units or nodes called artificial neurons. Each connection between artificial neurons can transmit a signal from one to another. The artificial neuron that receives the signal can process it and then signal artificial neurons connected to it.

In common artificial neural network implementations, the signal at a connection between artificial neurons is a real number, and the output of each artificial neuron is calculated by a non-linear function of the sum of its inputs. Artificial neurons and connections typically have a weight that adjusts as learning proceeds. The weight increases or decreases the strength of the signal at a connection. Artificial neurons may have a threshold such that only if the aggregate signal crosses the threshold is the signal sent.

The artificial neurons in an artificial neural network typically may be organized in layers. Different layers of artificial neurons in an artificial neural network may perform different types of transformations on their inputs. Signals travel from the first input layer to the last output layer of an artificial neural network, perhaps after traversing the layers multiple times.

A convolutional neural network, CNN, is a class of deep, feed-forward networks, composed of one or more convolutional layers with fully connected layers, matching those in typical artificial neural networks, on top. The architecture of convolutional neural networks allows them to take advantage of input data having a two-dimensional structure. Convolutional neural networks thus are suitable for processing visual and other two-dimensional data. Such networks have shown superior results in both image and speech applications.

Convolutional neural networks may be trained with standard backpropagation. Convolutional neural networks may be easier to train than other regular, deep, feed-forward neural networks and may have many fewer parameters to estimate.

Therefore, it would be desirable to have a method and apparatus that take into account at least some of the issues discussed above, as well as other possible issues.

### SUMMARY

The illustrative embodiments provide an artificial neural network comprising up-stream layers and down-stream layers. An output of the up-stream layers is provided as input to the down-stream layers. A first input to the artificial neural network to the up-stream layers is configured to receive input data. A second input to the artificial neural network to the down-stream layers is configured to receive context data. The context data identifies a characteristic of information in the input data. The artificial neural network is configured to identify a classification of the information in the input data at an output of the down-stream layers using the context data.

In another illustrative embodiment, a method of identifying a classification of information is provided. Input data is provided to a first input to an artificial neural network to up-stream layers of the artificial neural network, wherein the artificial neural network comprises down-stream layers, and wherein an output of the up-stream layers is provided as input to the down-stream layers. Context data is provided to a second input to the artificial neural network to the down-stream layers. The context data identifies a characteristic of information in the input data. A classification of the information in the input data is identified at an output of the down-stream layers by the artificial neural network using the context data.

In another illustrative embodiment, another method of identifying a classification of information is provided. Input data is provided from an input data source to a first input to an artificial neural network to up-stream layers of the artificial neural network, wherein the artificial neural network comprises down-stream layers, and wherein an output of the up-stream layers is provided as input to the down-stream layers. Context data is provided from a context data source to a second input to the artificial neural network to the down-stream layers. The context data identifies a characteristic of information in the input data. The context data source is an independent data source that is different from the input data source. A classification of the information in the input data is identified at an output of the down-stream layers by the artificial neural network using the context data.

The features and functions of the illustrative embodiments may be achieved independently in in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information processing system using an artificial neural network with a context pathway in accordance with an illustrative embodiment;

FIG. 2 is a block diagram of an artificial neural network with a context pathway for classifying objects in images in accordance with an illustrative embodiment;

FIG. 3 is an example of classifications and context in images in accordance with an illustrative embodiment; and

FIG. 4 is an illustration of results of adding context to an artificial neural network for classifying objects in images in accordance with an illustrative embodiment.

### DETAILED DESCRIPTION

The illustrative embodiments recognize and take into account one or more different considerations. For example, the illustrative embodiments recognize and take into account that it may be desirable to use convolutional neural networks in memory constrained environments. These include the growing segment of embedded processors available for Internet of things, IoT, devices as well as drones and autonomous vehicles.

Illustrative embodiments improve performance of a size-constrained network. Illustrative embodiments show a dramatic increase in performance without an increase in network size.

Illustrative embodiments provide a method and apparatus by which a camera or computer vision system can identify and classify objects. Illustrative embodiments provide an improvement over currently existing technologies by using parallel computational pathways to relay higher-level contextual information to decision making layers. In doing so, the decision making layers appropriately weigh options biased by the current context. Context may be provided by an auxiliary system or may be provided along with the information to be processed.

Utilizing parallel pathways within an artificial neural network in accordance with an illustrative embodiment allows the transmission of contextual information to higher-level decision making layers, thereby enabling higher efficiency on machine learning tasks. Illustrative embodiments therefore enable, for example, improved object recognition performance.

Illustrative embodiments may be implemented to improve the performance of any appropriate computer vision algorithms. For example, without limitation, illustrative embodiments may be implemented using a feed forward convolutional neural network.

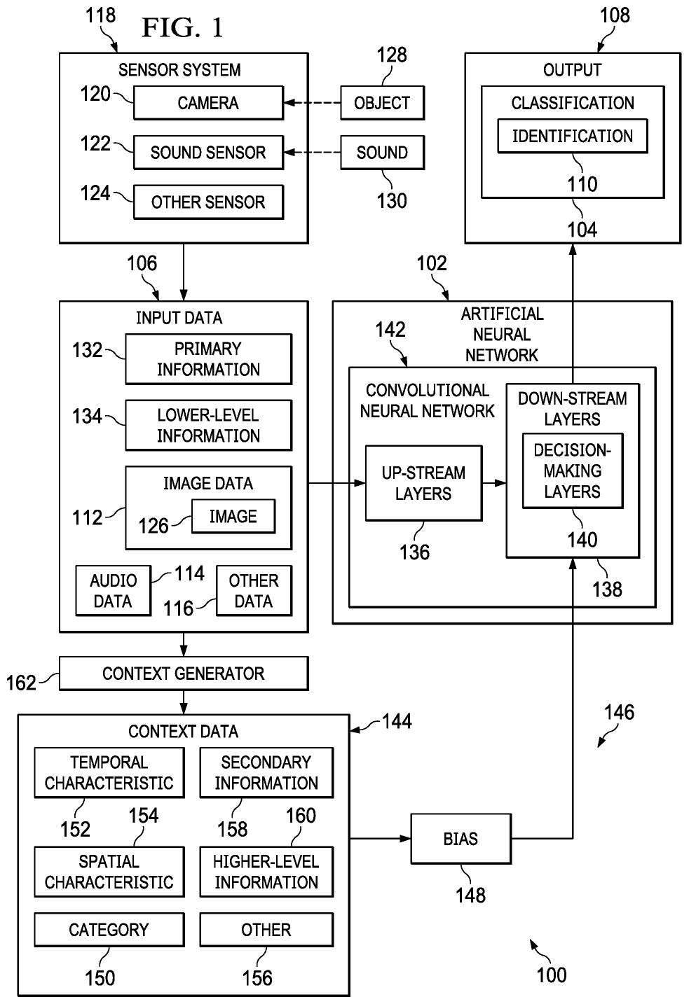

Turning to FIG. 1, an illustration of a block diagram of an information processing system using an artificial neural network with a context pathway is depicted in accordance with an illustrative embodiment.

Information processing system 100 uses artificial neural network 102 to determine classification 104 of information provided as input data 106 to artificial neural network 102. Classification 104 is thus provided as output 108 of artificial neural network 102. Identification 110 of information in input data 106 may be a specific example of classification 104 performed by artificial neural network 102 in which a particular classification has only one possible member.

Input data 106 may include any appropriate information that may be provided from any appropriate input data source to artificial neural network 102 in any appropriate format for processing by artificial neural network 102. For example, without limitation, input data 106 may comprise image data 112, audio data 114, other data 116, or various combinations of any appropriate data.

For example, without limitation, input data 106 may be provided by sensor system 118. For example, sensor system 118 may comprise camera 120, sound sensor 122, other sensor 124, or any appropriate combination of sensors. Camera 120 may be configured to provide image data 112 comprising information for image 126 of object 128. Image data 1112 may comprise two-dimensional or three-dimensional image data. Sound sensor 118 may be configured to provide audio data 114 representing sound 130.

In general, input data 106 may be considered primary information 132 in that classification 104 is determined by artificial neural network 102 using primarily input data 106. Input data 106 also may be considered lower-level information 134 in some cases.

Artificial neural network 102 comprises up-stream layers 136 and down-stream layers 138. Down-stream layers 138 may be referred to as decision-making layers 140 of artificial neural network 102. For example, without limitation, artificial neural network 102 may comprise convolutional neural network 142. Artificial neural network 102 may be a feedforward neural network or a recurrent neural network.

In accordance with an illustrative embodiment, input data 106 is provided at a first input to artificial neural network 102 at an input to upstream layers 136. Context data 144 is provided at a second input to artificial neural network 102 at down-stream layers 138. Context data 144 is thus provided to artificial neural network 102 on a context pathway 146. In accordance with an illustrative embodiment, context data 146 may provide bias 148 to nodes in down-stream layers 138 of artificial neural network 102 to improve the ability of artificial neural network 102 to determine classification of information in input data 106.

Context data 144 may comprise any appropriate data that may describe a characteristic of the information in input data 106 that is being processed by artificial neural network 102. For example, without limitation, context data 144 may identify category 150, temporal characteristic 152, spatial characteristic 154, other characteristic 156, or a combination of any appropriate characteristics of the information in input data 106 for which artificial neural network 102 is to determine classification 104.

In general, context data 144 may be considered secondary information 158 in that context data 144 is used secondarily to input data 106 by artificial neural network 102 to determine classification 104. Context data 144 also may be considered higher-level information 160 in some cases, in that context data 144 may not include as much detail as the information provided in input data 106.

Context data 144 may be provided by any appropriate context data source. For example, without limitation, context data 144 may be known in advance or provided with corresponding input data. Alternatively, context data may be generated from input data using context generator 162. As another example, context data 144 may be provided by an independent data source, such as a sensor that samples information at a different spatial or temporal scale from sensor system 118 that provides input data 106.

The illustration of information processing system 100 in FIG. 1 is not meant to imply physical or architectural limitations to the manner in which illustrative embodiments may be implemented. Other components, in addition to or in place of the ones illustrated, may be used. Some components may be optional. Also, the blocks are presented to illustrate some functional components. One or more of these blocks may be combined, divided, or combined and divided into different blocks when implemented in an illustrative embodiment.

For example, some or all of the functions performed by information processing system 102 may be implemented in sensor system 118. For example, without limitation, information processing system 102 may be a computer vision system implemented in camera 120.

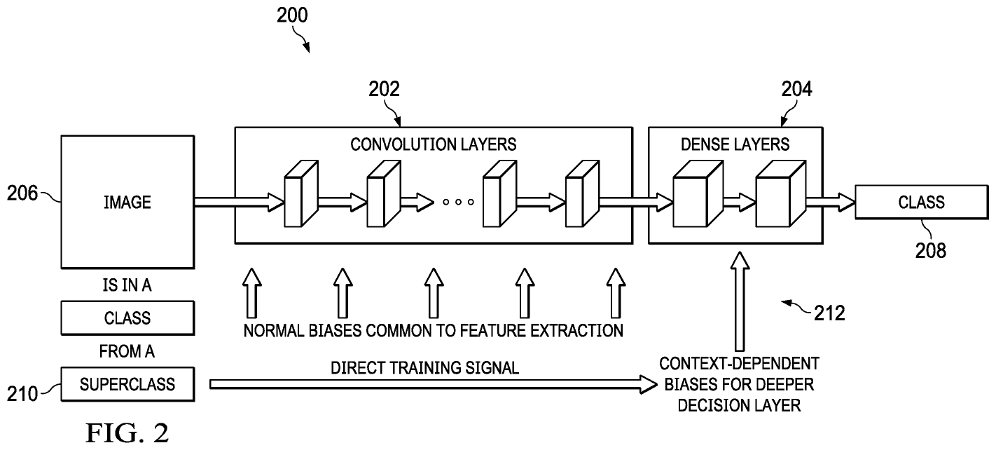

Turning to FIG. 2, a block diagram of an artificial neural network with a context pathway for classifying objects in images is depicted in accordance with an illustrative embodiment. Artificial neural network 200 an example of one implementation of artificial neural network 102 in FIG. 1.

In this example, artificial neural network 200 is a convolutional neural network comprising up-stream convolution layers 202 followed by down-stream dense layers 204. Artificial neural network 200 thus may be an example of one implementation of convolutional neural network 142 in FIG. 1.

In this example, artificial neural network 200 is configured to process image 206 to determine class 208 of image 206. Image 206 is provided as input data to the input of convolution layers 202.

In this case, class 208 of image 208 is from higher-level superclass 210. Information identifying superclass 210 is provided as context data on context pathway 212 as a direct input to dense layers 204 of artificial neural network 200. Context data identifying superclass 210 may be used to adjust the bias of nodes in dense layers 204 to improve the ability of artificial neural network 200 to identify class 208 of image 206.

Artificial neural network 200 thus adds a parameter and expands bias to be context-dependent. As a specific example, without limitation, for each input vector x, such as image 206, it may be assumed that there exists an accompanying context \hat{x}, such as superclass 210, which may be represented with a one-hot vector encoding. Formally, the output of a traditional artificial neural network layer may be computed as o(x)=ƒ(Ax+b) where A is a weight matrix, b is the bias, and ƒ is the activation function. For a context \hat{x}, instead of the classic bias, use o(x)=ƒ(Aₓ+b_{\hat{x}}), which represents the concept that the bias may depend on \hat{x}. Let δᵢ=1 if the context \hat{x} is i and δᵢ=0 otherwise. In this case, the layer can equivalently be written o(x)=ƒ(Aₓ+Σᵢδᵢb_{\hat{x}})=ƒ(Aₓ+B_{\hat{x}}), where B is a matrix representing each of the biases under each context.

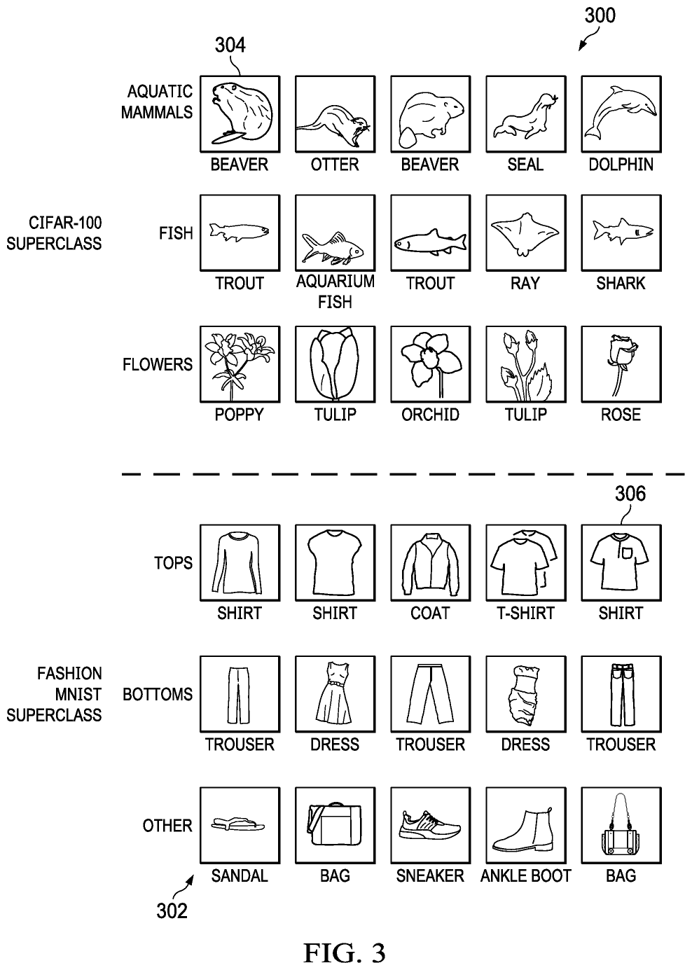

Turning to FIG. 3, an example of classifications and context in images is depicted in accordance with an illustrative embodiment. Images 300 and 302 may be examples of input data 106 in FIG. 1.

In this example, images 300 are from the CIFAR-100 image data set. For example, image 304 is in the classification “beaver”. Image 304 is in the superclass “aquatic animals”. “Aquatic animals” is thus an example of context information for image 304.

In this example, images 302 are from the Fashion MNIST image data set. For example, image 306 is in the classification “shirt”. Image 306 is in the superclass “tops”. “Tops” is thus an example of context information for image 306.

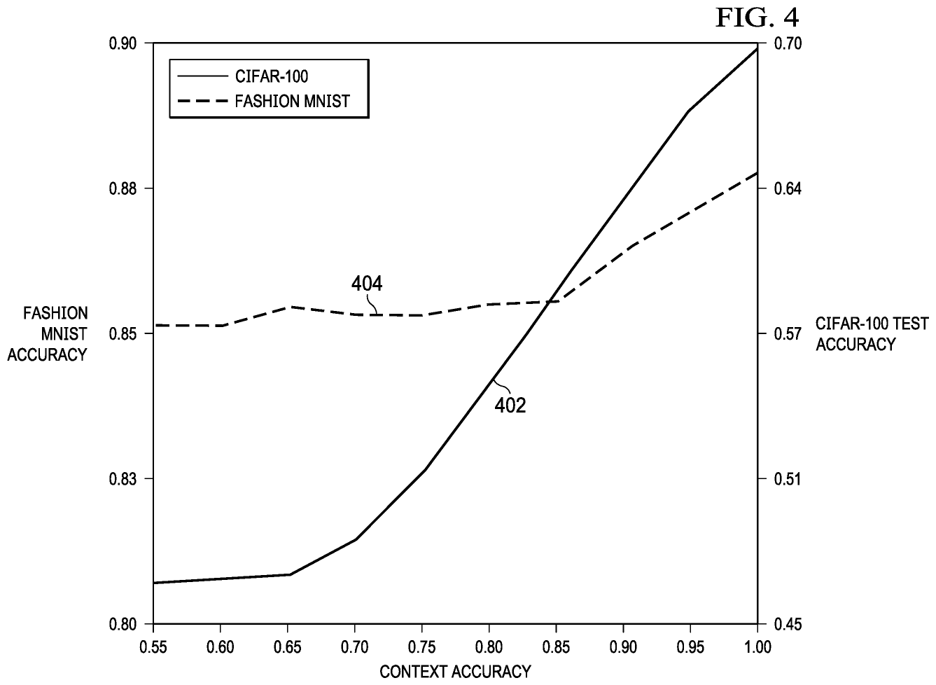

Turning to FIG. 4, an illustration of results of adding context to an artificial neural network for classifying objects in images is depicted in accordance with an illustrative embodiment. Results 402 show the results from adding context to an artificial neural network processing images from the CIFAR-100 image set. Results 404 show the results from adding context to an artificial neural network processing images from the Fashion-MNIST image set. In both cases, the accuracy of the classification of images improves as more accurate context information is provided.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An artificial neural network, comprising:
up-stream layers;
down-stream layers, wherein an output of the up-stream layers is provided as input to the down-stream layers;
a first input to the up-stream layers configured to receive input data;
a second input to the down-stream layers configured to receive context data, wherein the context data identifies a characteristic of information in the input data; and
wherein the artificial neural network is configured to identify a classification of the information in the input data at an output of the down-stream layers using the context data.

2. The artificial neural network of claim 1, wherein a bias of nodes in the down-stream layers changes in response to the context data.

3. The artificial neural network of claim 1, wherein the artificial neural network is a convolutional neural network wherein the up-stream layers comprise convolutional layers and the down-stream layers comprise dense layers.

4. The artificial neural network of claim 1, wherein:
the input data comprises image data;
the information in the input data comprises an image of an object; and
the artificial neural network is configured to identify the classification of the object at the output of the down-stream layers using the context data.

5. The artificial neural network of claim 1, wherein the input data comprises audio data and the information in the input data represents a sound.

6. The artificial neural network of claim 1 further comprising a context generator configured to generate the context data from the input data.

7. The artificial neural network of claim 1, wherein the context data identifies a selected one of a temporal characteristic of the information in the input data, a spatial characteristic of the information in the input data, or a category of the information in the input data.

8. A method of identifying a classification of information, comprising:
providing input data to a first input to an artificial neural network to up-stream layers of the artificial neural network, wherein the artificial neural network comprises down-stream layers, and wherein an output of the up-stream layers is provided as input to the down-stream layers;
providing context data to a second input to the artificial neural network to the down-stream layers, wherein the context data identifies a characteristic of information in the input data; and
identifying a classification of the information in the input data at an output of the down-stream layers by the artificial neural network using the context data.

9. The method of claim 8, wherein identifying the classification of the information in the input data comprises changing a bias of nodes in the down-stream layers in response to the context data.

10. The method of claim 8, wherein the artificial neural network is a convolutional neural network wherein the up-stream layers comprise convolutional layers and the down-stream layers comprise dense layers.

11. The method of claim 8, wherein:
the input data comprises image data;
the information in the input data comprises an image of an object; and
identifying the classification of the information in the input data comprises identifying the classification of the object at the output of the down-stream layers using the context data.

12. The method of claim 8, wherein the input data comprises audio data and the information in the input data represents a sound.

13. The method of claim 8 further comprising generating the context data from the input data.

14. The method of claim 8, wherein the context data identifies a selected one of a temporal characteristic of the information in the input data, a spatial characteristic of the information in the input data, or a category of the information in the input data.

15. A method of identifying a classification of information, comprising:
providing input data from an input data source to a first input to an artificial neural network to up-stream layers of the artificial neural network, wherein the artificial neural network comprises down-stream layers, and wherein an output of the up-stream layers is provided as input to the down-stream layers;
providing context data from a context data source to a second input to the artificial neural network to the down-stream layers, wherein the context data identifies a characteristic of information in the input data, and wherein the context data source is an independent data source that is different from the input data source; and
identifying a classification of the information in the input data at an output of the down-stream layers by the artificial neural network using the context data.

16. The method of claim 15, wherein identifying the classification of the information in the input data comprises changing a bias of nodes in the down-stream layers in response to the context data.

17. The method of claim 15, wherein the artificial neural network is a convolutional neural network wherein the up-stream layers comprise convolutional layers and the down-stream layers comprise dense layers.

18. The method of claim 15, wherein:
the input data comprises image data;
the information in the input data comprises an image of an object; and
identifying the classification of the information in the input data comprises identifying the classification of the object at the output of the down-stream layers using the context data.

19. The method of claim 15, wherein the input data comprises audio data and the information in the input data represents a sound.

20. The method of claim 15, wherein the context data identifies a selected one of a temporal characteristic of the information in the input data, a spatial characteristic of the information in the input data, or a category of the information in the input data.
